(19) United States
(12) Patent Application Publication
(10) Pub. No.: US 2026/0318807 A1
(43) Pub. Date: Oct. 15, 2026

(54) FILTER REPLACEMENT ALARM MECHANISM

(71) Applicant: HEWLETT PACKARD ENTERPRISE DEVELOPMENT LP, Spring, TX (US)

(72) Inventors: Yu-Hui Zeng, Changhua City (TW); Tsai-Ying Fang, New Taipei City (TW); Liang-Chun Lu, Tainan City (TW)

(21) Appl. No.: 19/174,466

(22) Filed: Apr. 9, 2025

(51) Int. Cl. G01N 15/08

(52) U.S. Cl. CPC G01N 15/08; G01N 2015/084

(57) ABSTRACT

A method and a system that includes instructions to initiate a filter test and set a speed of cooling fans of an information processing system to a predetermined speed for the duration of the filter test. The instructions further include acquiring temperature and power test data indicative of thermal resistance of one or more components of the information processing system during the filter test, and calculating the thermal resistance of the one or more components for the filter test based on the temperature and power test data. Moreover, in response to determining that the thermal resistance of the one or more components is greater than or equal to a thermal resistance threshold, the instructions include issuing a notification to replace an air filter of the information processing system.

### INTRODUCTION

Information processing devices can include filters that prevent accumulation of dust, dirt and other particles within the server hardware. The dust filters are typically placed over the inlet ventilation openings of servers. During system operation, dust may thus collect on these filters. In some cases, the filters are designed to be occasionally removed and replaced. Often, organizations schedule periodic replacements in an attempt to ensure that the filters get replaced before they become overly clogged.

The filter replacement may be triggered by setting up an alarm with a timer to evaluate or replace a filter. Once the preset time duration of the timer lapses, a warning signal is triggered to check the filter.

### BRIEF DESCRIPTION OF THE DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more examples of the present teachings and together with the description explain certain principles and operations. In the drawings:

FIG. 1 is a block diagram schematically illustrating an information processing system with components of a filter replacement mechanism.

FIG. 2 is a graph showing change in the component thermal resistance of two filters at different fan speeds.

FIG. 3A is a top view illustrating an information processing system with components of a filter replacement mechanism with a new filter installed; FIG. 3B is a top view illustrating an information processing system with components of a filter replacement mechanism with a dispensable filter installed.

FIG. 4 is a flowchart including steps of a filter check procedure according to one example.

FIG. 5 is a flowchart including steps of a filter check procedure according to another example.

FIG. 6 is a graph showing changes of fan speed in the course of time in different operation modes.

### DETAILED DESCRIPTION

The approach where air filters are replaced periodically needs improvement because whatever replacement interval is scheduled, it is unlikely that it will be optimal because it does not account for specific circumstances surrounding the air filters. Some filters might become overly obstructed before the scheduled replacement, which can drop system efficiency and performance below an acceptable level. Others might be very lightly obstructed and thus still serviceable when they are replaced, which is wasteful. It can be challenging to schedule a uniform replacement interval that is optimal because the rate at which a filter becomes clogged is highly variable.

The rate of clogging may depend on things such as the amount of dust in the air around the server, the type of the dust (e.g., particle size), the amount of airflow through the server, and other factors. These factors may vary from place to place (for example, some environments may have more substantial dust or higher particle density than other environments) and from time to time (e.g., dust amounts in the environment may change as the weather changes, the amount of airflow through a server may vary over time, etc.).

In order to minimize the risk of inadequate airflow in servers, air filters need to be occasionally removed and replaced. Examples disclosed herein provide a filter monitoring and replacement alarm mechanism which can actively monitor the degree to which the filter is obstructed and generate an alarm signal indicating that filter replacement is advisable when the filter has become too obstructed. Evaluating and monitoring air filter performance towards its limit and ascertaining the moment at which replacement is recommended allows for better suited decisions regarding filter replacement than a one-size-fits-all approach.

Rather than observing the filter directly to determine the degree of obstruction (such as through an optical sensor or the like), the filter monitoring and replacement alarm mechanism may monitor the degree of obstruction of the filter indirectly by occasionally determining the thermal resistance of one or more components of the system under known conditions (e.g., with the fans operating at a predetermined speed) and comparing that thermal resistance to a threshold thermal resistance. If the determined thermal resistance exceeds the threshold, then the monitoring mechanism may generate an alarm signal indicating that the filter needs to be replaced. In other words, the thermal resistance of the component(s) is monitored as a proxy for detecting the degree of obstruction of the filter.

The thermal resistance of a component can be determined from data which is readily available to the system, often using sensors which are already included in most systems for other purposes. This data may include the temperatures of the component(s), the temperature of the air, and the amount of power being consumed by the component(s). Thus, the filter monitoring and replacement alarm mechanism can be implemented without the additional costs and complexity which might be associated with adding special-purposes sensors for directly observing the filter.

The thermal resistance of a component in the system can act as a good proxy for the degree of obstruction of the filter for the following reasons. The thermal resistance of a component is a parameter that reflects how large of a temperature difference is needed between the component and the air around it to dissipate a given amount of heat into the air. The thermal resistance of a component depends on many factors, notably including the rate of airflow over the component-lower airflow rates result in higher thermal resistance, and vice versa. Because the thermal resistances of the components depend on airflow rates, they can be used to infer the degree of obstruction of the filter. As the filter gets clogged, the amount of airflow generated by the fans at a given fan speed is reduced. As a result, the thermal resistance of the power-consuming components of the server increases, assuming all other things remain equal. Accordingly, if an increase in thermal resistance relative to a baseline is detected, this implies that the airflow through the system has decreased as compared to the baseline. Moreover, if the fans were controlled to operate at the same predetermined speeds for both measurements, then that means the decreased airflow can be attributed to increased obstruction of the filter. Thus, the increased thermal resistance of the component relative to the baseline can be correlated with increased obstruction of the filter.

Being that the accumulation of the particles on the filter is gradual, the reduced cooling efficiency is also gradual, and can, therefore, be gradually monitored in the course of time. At the same time, the steady increase in thermal resistance of the components can be used as a variable that is indicative (or dispositive) of the condition of the server's air filter.

As mentioned, the thermal resistance reflects how large of a heat difference is needed to dissipate a given amount of heat. More specifically, the thermal resistance is expressed as a temperature difference (“ΔT”), which is the difference between the temperature of the component and the temperature of the air which impinges on the component, divided with the amount of heat being dissipated from the component per unit time (“Q”), i.e., ΔT/Q. Generally, when a system has reached a steady state, the amount of heat being dissipated by the component per unit time will be approximately equal to the amount of power being consumed by the power-consuming component of interest (“P”), and therefore the thermal resistance of the component may be approximated as the temperature difference divided by the power consumed, i.e., ΔT/P. In other words, the thermal resistance amounts to a temperature difference over the rate of heat removal from the power-consuming component.

The temperature difference can be approximated as the difference between a certain reference air temperature (e.g., ambient or baseline temperature), external to and upstream from the power-consuming component, and the temperature of the component, itself. The greater this difference is for a given rate of heat being dissipated, the higher the thermal resistance is. At the same time, if the power consumed by the monitored (key) component is greater, thus generating heat at a greater rate, all the other factors being equal (e.g., the fan speed, ambient temperature, etc.), the airflow cooling performance is considered to be greater (and the thermal resistance is lower).

As the filter accumulates dust, the overall airflow within the system decreases and the thermal resistance of the power-consuming components rises because the components are receiving airflow at a reduced rate. In some examples, one component is selected to have its thermal resistance monitored in order to determine the filter's status. Such a component may be referred to as a monitored component and its thermal resistance is deemed representative of the degree of obstruction of the filter. In other examples, the thermal resistances of multiple components may be monitored and they may individually or collectively determine the degree of obstruction of the filter.

Being that the goal of monitoring the thermal resistance of the monitored component is to decide when to replace the air filter, it is of significance to select the threshold thermal resistance so that the replacement alarm is triggered close to the moment when the filter has reached its limit and needs to be replaced. In other words, the predetermined threshold of thermal resistance is set to reflect an unacceptable condition of the filter, e.g., the moment when the filter needs to be replaced to avoid unacceptable levels of degradation of system cooling and/or performance. Once this level of air impermeability of the filter is detected, a filter replacement alarm signal is generated, which may activate a visual or audio alarm, informing the server operator to replace the air filter.

Turning now to the figures, various devices, systems, and methods in accordance with aspects of the present disclosure will be described.

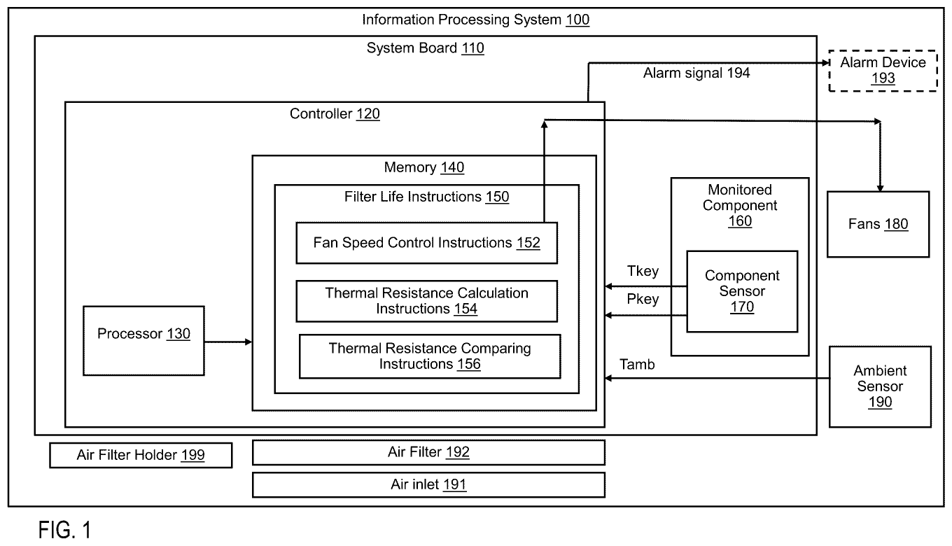

FIG. 1 is a block diagram schematically illustrating an information processing system 100, such as a server with a system board 110, e.g., a motherboard of the server. The system board 110 may be the main circuit board of the system 100 acting as the central hub that connects the components of the server, allowing them to communicate and function together.

The system board 110 houses controller 120. The controller 120 comprises one or more information processing components which collectively control various operations of the system, including operations pertaining to the filter replacement alarm mechanism described below. In some examples, these information processing components may include a processor 130 and a memory 140 storing instructions executable by the processor 130, including filter life instructions 150. In some examples, the information processing components may include special-purpose hardware devices such as an application specific integrated circuit (ASIC), a complex programable logic device (CPLD), a field programmable gate array (FPGA), etc., which are configured to perform the operations described herein. In other words, the controller 120 may comprise logic to perform the operations described herein, and this logic may comprise special purpose hardware, a processor coupled with a memory storing instructions executable by the processor, or some combination of these. In some examples, the controller 120 may be a baseboard management controller (BMC) of the system 100 and the memory 140 may be non-volatile memory of the BMC. In some examples, the controller 120 may be a logic device (e.g., CPLD) which controls low level operations of the system board 110. In some examples, the controller 120 may be a central processing unit (CPU) or system-on-chip (SoC) of the system, in which case the processor 130 may be a general purpose processor of the CPU/SoC and the memory 140 may be a non-volatile data storage device (e.g., hard drive, SSD, etc.) communicably coupled thereto.

Further, the system board 110 manages system memory (not illustrated), i.e., random access memory (RAM) and read only memory (ROM) by providing slots for RAM, used for system speed and multitasking. The system board 110 also may handle storage connections by supporting various other non-volatile data storage devices such as hard disk drives (HDDs), solid state drives (SSDs), and non-volatile memory (NVM) drives, via interfaces such as Serial ATA (SATA), M.2 slots, etc. The system board 110 also provides power distribution from a power supply unit (PSU, not shown) to the server components. In addition to providing expansion slots and controlling input and output (I/O) ports, the system board 110 manages data communication by controlling data flow between the processor 130, the memory 140 and the peripherals.

The system 100 also includes a monitored component 160. The monitored component 160 is an electrical component of the system, such as a CPU mounted to the system board 110. In some examples, the monitored component 160 is part of, or mounted to, the system board 110, as shown in FIG. 1. In other examples, the monitored component 160 could be separate from the system board 110 (e.g., a peripheral component).

The system 100 includes a cooling subsystem, which includes various devices such as fans 180, to regulate the temperature of monitored component 160 and other server components. The system 100 includes a component sensor 170 used to measure the temperature of the monitored component 160 during operation. The component sensor 170 may be provided as part of the monitored component 160. For instance, in examples where the monitored component 160 is a CPU or SoC, the component sensor 170 may be an internal temperature sensor included within the CPU package or SoC. Alternatively, the component sensor 170 may be distinct from the monitored component 160 but may be thermally coupled (e.g., placed in contact) with the monitored component such that it can sense the temperature of the monitored component 160.

In addition, the system 100 may include an ambient sensor 190 configured to sense the temperature of air at a predetermined location within the system 100 (e.g., within a chassis (not illustrated) of the system). In some examples, the system board 110 may accommodate the ambient sensor 190 mounted thereto or may provide a connection to the ambient sensor 190, depending on whether the ambient sensor 190 is located within or outside the system board 110. The ambient sensor 190 may be a temperature sensor, and the measurements of the ambient sensor 190 (Tamb) may be used in computations for reference as a baseline temperature, as will be explained in detail below. In some examples, the ambient sensor 190 is positioned within an airflow path that passes over the monitored component, with the ambient sensor 190 upstream of the monitored component 160. In some examples, the ambient sensor 190 is positioned immediately upstream of the monitored component 160, meaning that there are no significant heat generating components located in the airflow path between the ambient sensor 190 and the monitored component 160 such that the temperature sensed by the ambient sensor 190 is substantially equal to the temperature of the air when it reaches the monitored component.

In the example shown in FIG. 1, the fans 180 are used as a cooling system that creates airflow through and within the information processing system 100 and reduces the temperature of the server components by convection of heat to the air. Cool air enters a chassis of the system 100 via an air inlet 191 in the chassis, the air flows over/around the electronic components of the system 100 and absorbs heat therefrom, and the heated air then exits the chassis via an air outlet (not illustrated). The fan speed is variable and the capacity of each of the fans 180 ranges from 0% capacity when a fan is inactive to 100% when the fan operates at its maximum speed.

In some examples, the controller 120 controls the speed of the fans 180, either via fan speed control instructions 152 or via dedicated hardware configured to control the fan speed. The fan speed control instructions 152 may be stored in the memory 140, together with other filter life instructions 150 used by the processor 130, such as thermal resistance calculation instructions 154 and thermal resistance comparing instructions 156, which will be described in detail below. As the processor 130 executes the fan speed control instructions 152, the processor 130 causes the controller 120 to drive the fans 180 at a desired fan speed.

In other examples, the speed of the fans 180 may be controlled by another controller besides the controller 120. In such cases, the controller 120 may communicate with the other controller to request that it change the fan speeds during a filter life test operation, as will be explained in greater detail below.

In general, the fan speeds may be controlled, either by the controller 120 or by another controller, by pulse-width-modulation (PWM) signals sent to the fans 180, with the speed being indicated by the duty cycle of the PWM signal. At least two fan control modes may be used by the controller 120 or the other controller to control the fan speed: a normal operation mode and a filter test mode. In the normal operation mode, the fans 180 may be driven according to any desired fan operation algorithm, such as algorithms wherein the fan speed is varied based on sensed temperatures (e.g., component temperatures, etc.) according to a programmed fan curve. In the filter test mode, the fans 180 may be driven in a different manner, which is described in more detail below.

The fans 180 draw air from the environment external to the system 100 through an air inlet 191, and the outside air passes through an air filter 192 before the air provides cooling to the server components. The higher the operating fan speed is, the stronger the force is that the fans 180 exert on the air filter 192 to draw the air from the air inlet 191 to be passed through the filter 192. The air filter 192 selectively passes air through while stopping dust, dirt and other undesired solid particles from entering the server.

The air filter 192 may be removably held by an air filter holder 199 of the system 100. The air filter holder 199 may include a portion of the chassis (not illustrated) of the system 100 which receives the air filter 192. In some examples, the air filter holder 199 may include attachment features which engage the air filter 192 to secure it to the chassis, such as grooves into which side edges of the air filter 192 extend, latches which latch onto the air filter 192, fastener holes which receive fasteners to secure the air filter 192, etc. In some examples, the air filter holder 199 does not include any attachment features which affix the filter 192 to the chassis, and instead the fastener holder 192 may merely comprise a space within the chassis in which the filter 192 can be removably disposed, with the chassis directly or indirectly supporting the filter 192 when installed in this space.

While a new, clean filter 192 remains in operation, the collected particles accumulate, thereby reducing air permeability of the air filter 192 with time. This requires the fans 180 to run at higher speeds, and thus consume more power, in order to produce a given rate of airflow through the system 100. Accordingly, after a certain period of time, for the same fan speed, the cooling efficiency of the fans 180 decreases due to the gradual clogging of the air filter 192. Looked at another way, if the fans are operated at a given speed, then the amount of airflow they will generate at that same speed will be reduced as the filter 192 becomes more clogged.

Thus, one way to detect that a filter has become obstructed is to detect that the amount of airflow the fans can generate at a given fan speed has been reduced relative to when the filter was clean. However, directly measuring airflow amounts can be difficult and may require additional sensors. Thus, in examples disclosed herein, the controller 120 may monitor other parameters, which are related to the airflow amounts but which are easier to measure, and use these to infer the condition of the filter 192. In particular, the thermal resistance of the monitored component 160 of the system 100 depends on the rate of airflow through the system, which in turn depends upon the condition for the filter 192 (assuming constant fan speed). Thus, the controller 120 may use the thermal resistance of the monitored component 160, measured at a predetermined fan speed, as a proxy which is indicative of the condition of the filter 192: the thermal resistance increases as the filter 192 becomes more obstructed. Furthermore, the controller 120 may determine that it is time to replace the filter 192 when the measured thermal resistance of the component 160 matches (or exceeds) a predetermined threshold, as explained below. This threshold may be chosen to represent the expected thermal resistance of the component 160 when the filter 192 is in a replacement-needed condition (assuming the fans 180 operating at the same predetermined fan speed).

In some examples, the threshold is chosen in advance by system designers, based on experimentation, analysis, of their experience, and programed into the controller 120. Thus, in such examples, the controller 120 does not necessarily actively determine or choose the threshold, but rather may obtain the threshold by reading a programed value stored in memory. The threshold may be determined experimentally, for example, by installing a fresh filter in a test server, running the test server, determining a timing at which the filter has reached a replacement-needed state based on any desired criteria (e.g., visual observation of the filter, measurements of power usage by the fans, observation of performance of the monitored component, etc.), measuring the thermal resistance of the monitored component at this timing, and setting the threshold based on the measured thermal resistance. In some cases, the threshold could be set to equal the measured thermal resistance (or a value offset from the measured thermal resistance by some predetermined amount). The threshold may be set analytically, for example, by estimating a maximum acceptable thermal resistance for the component, which is a thermal resistance at which the performance of the monitored component, efficiency of the fans, or other metrics of interest to the system designer become unacceptably degraded, and then setting the threshold to equal this maximum acceptable value (or some offset therefrom).

In other examples, the threshold may be chosen or updated by the controller 120. In such cases, the controller 120 may determine the threshold by, for example, measuring a baseline thermal resistance of the monitored component when the filter is known to be new, and then setting the threshold thermal resistance based on the measured baseline. Setting the threshold based on the measured baseline may include, for example, setting the threshold to a value that is a predetermined offset higher than the measured baseline, which could be a fixed offset or a variable offset (e.g., a proportional or percentage-based offset). In some examples, the baseline and threshold determination may be repeated occasionally, with the values being updated accordingly. In some examples, this process is performed and the values are updated in response to certain conditions being detected, such as detecting a first system startup, detecting a change in configuration of the information processing system (e.g., a new component is added, an existing component is removed, etc.), or detecting a change in an external environment of the information processing devices (e.g., a change in location is detected, a change in humidity is detected, etc.). The predetermined offset that is used can be determined by system designers in advance and programmed into the controller 120. The offset may be determining a baseline for test system (real, or modeled), determining a threshold using one of the methods discussed in the preceding paragraph, determining the difference between the baseline and the threshold, and setting the offset to be equal to (or some difference from) the determined difference. Updating the threshold occasionally in this manner can be helpful in cases where the deployment conditions and configuration of the system are not known in advance or can change over time, as the thermal resistance can be affected by variations in conditions and configuration, which may make it difficult for a single threshold to be optimal in all cases.

The cooling efficiency is also inversely related to the thermal resistance of the component 160 of the system 100, i.e., a reduction in cooling efficiency results in an increase in thermal resistance. Consequently, the computation of the thermal resistance of the component 160 may also be used to evaluate the cooling efficiency of such a component.

In one example, the monitored component 160 is a component of the system 100 that is selected as representative of the entire system 100 in terms of cooling performance. In other words, the determination of the airflow produced by the fans 180 with respect to the system 100 may be evaluated based on the cooling effect on the monitored component 160 observed in isolation. In another example, the airflow by the fans 180 in regards to the system 100 may be evaluated based on the cooling effect on two or more components including the monitored component 160.

As mentioned, the component sensor 170 may include one or more sensors, such as a sensor to determine power consumption of the monitored component 160 (Pkey) and/or a temperature sensor measuring the temperature of the monitored component 160, with this measured temperature being designated herein as They. In one example, the power consumption determination is an integral function of the central processing unit (CPU) or the voltage regulator module (VRM) of the monitored component 160. In other words, the power consumption of the monitored component 160 (Pkey) can be ascertained, for example from power delivery circuitry of the system board 110 and/or from the component 160 itself. The more active the monitored component 160 is, the more power it consumes, thereby generating heat at a higher rate. As a result, the increased (or decreased) heat generation requires a greater (or lower) cooling capacity. Therefore, for the same cooling efficiency of the representative monitored component 160, increased power generation of the component 160 increases Tkey of the monitored component 160. That said, the controller 120 may be configured to determine the thermal resistance Rt of the monitored component (Rtkey) of the information processing system 100, e.g., of the monitored component 160, by obtaining Tkey, Pkey, and Tamb and calculating Rtkey from these values using the following equation:

$$Rtkey = \frac{Tkey - Tamb}{Pkey} \qquad Equation 1$$

Rtkey is the thermal resistance of the monitored component 160 of the system 100, Tkey is the temperature measured by the component sensor 170, Tamb is the ambient temperature measured by the ambient sensor 190 and Pkey is the power consumed by the monitored component 160. Equation 1 may be included in the thermal resistance calculation instructions 154, stored in the memory 140, or may be encoded in logic of a dedicated hardware of controller 120.

In one example, the controller 120 is configured to use the result of the Rtkey computation in a decision whether to replace the air filter 192 by comparing Rtkey with a predetermined threshold value Rtlimit. In particular, if Rtkey is greater than or equal to Rtlimit, the controller 120 may determine that the filer 192 needs to be replaced, and take actions accordingly. Operations for comparing Rtlimit and Rtkey, and the resulting actions to be taken if Rtkey is greater than or equal to Rtlimit, may be included in the thermal resistance comparing instructions 156, stored in the memory 140, or may be encoded in logic of a dedicated hardware of controller 120. The threshold Rtlimit may correspond to a value of the thermal resistance of the monitored component 160 expected to be observed when the air filter 192 has just reached its replacement-needed condition (i.e., a condition of the filter 192 where is advisable to replace the filter to avoid unacceptable levels of efficiency/performance degradation). In other words, the moment in time when Rtkey reaches or exceeds the level of Rtlimit is treated as the moment when the air filter 192 needs to be replaced.

Notably, Rtlimit depends on the environmental factors, such as speed of the fans 180 for example. In other words, Rtkey and Rtlimit are compared for all environmental factors being equal, other than the variables measured and used for the Rtkey computation. As a result, as will be described in detail below, before the computation of Rtkey commences, the fans 180 need to be set at a constant predetermined speed that corresponds to the speed at which Rtlimit was previously established and stored in the memory 140.

The processor 130 may load the filter life instructions 150 from the memory, including, for example, the thermal resistance calculation instructions 154 in order to process Equation 1 and compute Rtkey. Then, the processor 130 may load the thermal resistance comparing instructions 156 and to determine whether Rtlimit has been reached, when the air filter 192 needs to be changed. In case that Rtkey reaches Rtlimit, the processor 130 informs the controller 120 and the controller 120 generates an alarm signal 194. The alarm signal 194 is an electronic signal configured to indicate that replacement of the filter is recommended. The alarm signal 194 may be sent to another entity, which may be part of the system 100 in some examples or which may be distinct from the system 100 in other examples, as explained in more detail below. In some instances, the alarm signal 194 may itself be configured to directly indicate to the recipient that filter replacement is needed. In other instances, the alarm signal 194 may indirectly indicate replacement is needed by causing the recipient (such as a hardware or software entity) to perform certain predetermined functions, with these functions then serving to indicate that replacement is needed.

In some implementations, system 100 further comprises an alarm device 193 and the alarm signal 194 may be configured to indicate replacement is recommended by activating the alarm device 193. The alarm device 193 may, for example, provide a visual or audio signal or any other perceptible indication suitable for informing the server operator that it is time to remove and replace the used up air filter 192.

For instance, the alarm device 193 may include, in various examples, a speaker, a light (e.g., an LED), a display screen, which may include a graphical user interface (GUI), and/or the like. In examples in which the alarm device 193 comprises a light, the alarm device 193 may provide the visual signal by altering an operation of the light, which may include turning the light on or off, changing a color of the light, changing a blink pattern of the light, or the like. In examples in which the alarm device 193 comprises a display screen/GUI, the alarm device 193 may provide the visual signal by displaying a graphical or textual representation on the display screen. In examples in which the alarm device 193 comprises a speaker, the alarm device 0193 may provide the audio signal by providing a noise or a voice message via the speaker.

In some implementations, the alarm signal 194 may comprise an electronic notification, which may be provided in addition to or in lieu of the signal which controls the alarm device 193. The electronic notification may include, in various examples, an email, a text message, a text document, or the like which is sent to an operator or other predetermined destination or account or which is stored in a storage device, which may be part of system 100 or remote from system 100. The electronic notification may also include, in various examples, a command, instruction, API call, digital code, or the like which is sent to a hardware or software entity (e.g., an operating system (OS), a system management program, a rack controller, etc.) and which is configured to notify the hardware or software entity that filter replacement is recommended. This hardware or software entity could be part of the system 100, in some examples, or distinct from the system 100, in other examples. The hardware or software entity may take further actions based on this information according to its programming, which may include, in some examples activating an alarm device (which may be part of system 100, like alarm device 193, or which may be some other alarm device not part of the system 100, such as an indicator alarm on a rack in which system 100 is deployed), recording the information in a log for subsequent retrieval, or any other desired action.

Examples of the alarm signals, electronic signals, electronic notifications and/or other perceptible indications mentioned above, produced by an alarm device and/or other hardware or software components of the system can be considered a notification.

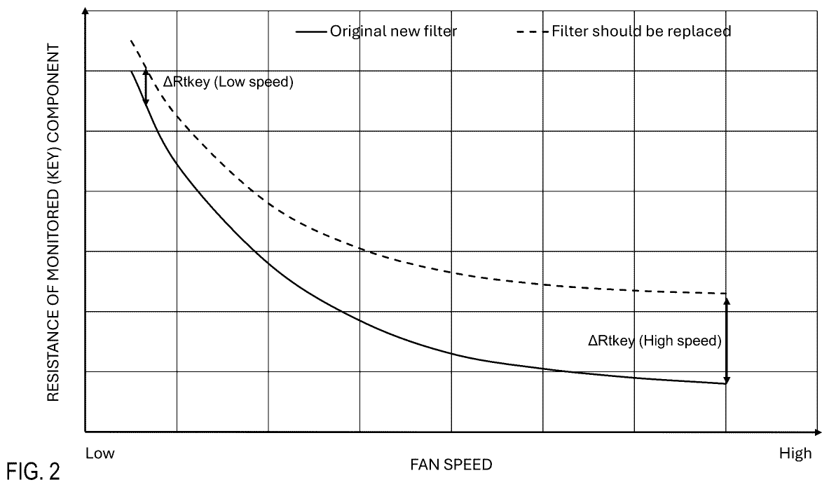

Turning to FIG. 2, the difference (split) between the cooling efficiencies (ΔRtkey) resulting respectively from using a new filter or a clogged filter may keep increasing as the rotation speed of the fans 180 increases. The cooling performance reduction caused by a clogged filter may not be as detectable when the fan speed is low, compared to a more severe reduction when the filter is clogged and the fan speed is high (ΔRtkey at low speed<<ΔRtkey at high speed).

In one example, this attenuation of cooling efficiency at the high fan speed is used for reliability of decision making whether to replace the filter 192. Namely, the high speed of the fans 180 significantly props up the airflow of the system 100 even with a clogged filter 192. Therefore, if the controller 120 instructs the fans 180 to operate at a very high (e.g. maximum) speed and the thermal resistance of the system is nonetheless excessive, the decision to replace the air filter 192 may be particularly credible. For this reason, constant fan speed set prior to the Rtkey computation may be on the high end of the fan capacity range. In one example, the constant fan speed prior to the Rtkey computation is set to be greater than 50% of the capacity of the fans 180. In another example, the constant fan speed set prior to the Rtkey computation is set approximately at 100% of the capacity of the fans 180.

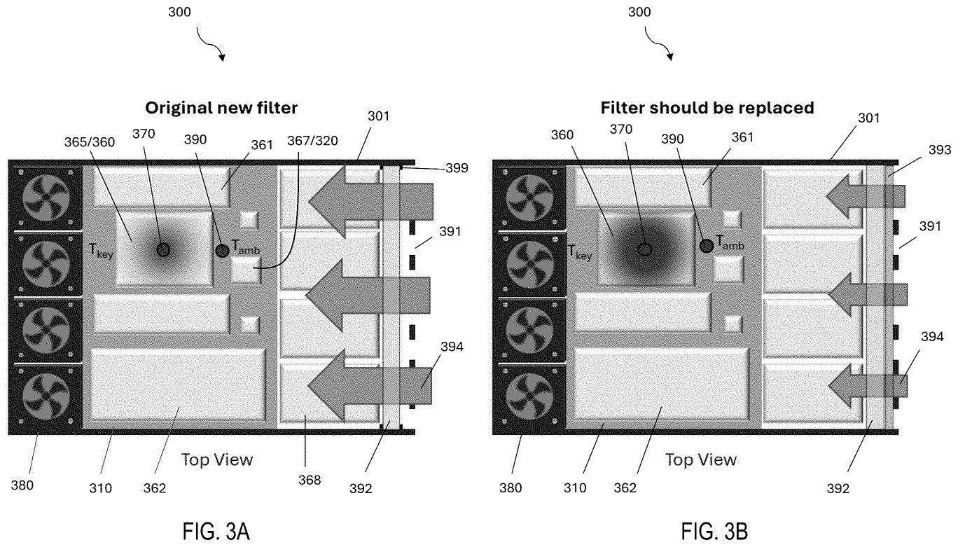

FIGS. 3A and 3B illustrate an information processing system 300. The system 300 is an example of the information system 100 shown in FIG. 1. Thus, some components of the system 300 are examples of corresponding components of the system 100, with these corresponding components being given similar reference numbers having the same last two digits, such as 160 and 360. As an example of the system 100, the system 300 represents one of the many possible ways that the system 100 could be implemented. However, the system 100 is not limited to the system 300, and descriptions below of aspects specific to the system 300 do not necessarily apply to, and do not limit, other implementation examples of the system 100.

The system 300 is shown in at two stages, with the air filter in different conditions. FIG. 3A depicts the information processing system 300 when an original new filter 392 is installed, and FIG. 3B illustrates the information processing system 300 when a layer of particles 393, such as dust, dirt, etc., is accumulated on the air filter 392.

The system 300 may be a server which includes a chassis 301 that accommodates a system board 310, e.g., a motherboard of the server. The chassis 301 includes a base and one or more walls defining a housing or enclosure, which includes an air inlet 391. The chassis 310 includes an air filter holder 399 which removably receives an air filter 392 and supports the filter 392 in a position in which the air filter 392 can filter air which enters the chassis 301 through the air inlet 391.

The system 300 also comprises various information processing components, some of which are mounted to the system board 310 and others of which are peripheral components which are separate from the system board 310 but electrically connected thereto, e.g., by cables. Some of the components mounted to the system board include a CPU 365, memory modules 361, a graphics processing unit 362, and a BMC 367. Some of the peripheral components may include data storage drives 368.

In this example, the CPU 365 also happens to be the monitored component 360, which is an example of the monitored component 160, and the CPU 365/monitored component 360 is therefore monitored as part of the filter replacement alarm mechanism disclosed herein. Furthermore, in this example the BMC 367 also happens to be the controller 320, which is an example of the controller 120, and therefore the BMC 368/controller 320 performs control operations associated with the filter replacement alarm mechanism. However, as explained above with respect to FIG. 1, in other examples other components could serve as the monitored component 160 or controller 120.

The system 300 also includes fans 380 to regulate the temperature of components of the system, including the monitored component 360 and other server components. The monitored component 360 includes a component sensor 370 used to measuring the temperature of the monitored component 360. In addition, the system board 310 may comprise an ambient sensor 390 which is an example of the ambient sensor 190 that is, in this example, mounted to the system board 310. The ambient sensor 390 may be a temperature sensor, and the measurements of the ambient sensor 390 (Tamb) may be used in computations for reference as a baseline temperature, as will be explained in detail below. In this example, the ambient sensor 390 is located immediately upstream from and near the monitored component 360 in terms of the airflow 394 from the inlet 391, as shown in FIG. 3A. However, in other examples example, the ambient sensor 190 may be located farther from the monitored component 160 within the server, e.g., at an air inlet.

The system 300 also includes fans 380, which draw airflows 394 into the chassis 301 from the environment external to the system 300 through the air inlet 391. These airflows 394 pass through the air filter 392 before the air provides cooling to the server components. In the illustrated example, the air filter 392 is disposed downstream of the inlet 391, but in other examples it can be disposed upstream of the inlet. In one example, the air inlet 391 is on at the front panel of the system 300 while the fans 380 are positioned at the back panel. In another example, the air inlet 391 is at the back panel and the fans 380 are located at the front panel. In still other examples, the fans 380 could be located in a middle of the chassis 301, such as in a space between the storage drives 368 and the system board 310. The higher the operating fan speed is, the stronger the force of the pressure differential is that the fans 380 exert on the air filter 392 to draw the air from the air inlet 391 to be passed through the filter 392. The air filter 392 selectively passes air through while stopping dust, dirt and other undesired solid particles from entering the server.

The comparison between FIGS. 3A and 3B shows that when the air filter 392 is clean, i.e., when the layer of particles 393 is not present or minimal, the airflow 394 passing through the filter 392, when the fans 380 operate at a given fan speed, is abundant. In contrast, after some time has passed the collected particles 393 accumulate on the filter 392 resulting in the state shown in FIG. 3B in which the particles 393 partially obstruct and reduce air permeability of the air filter 392 with time. Consequently, in the state of FIG. 3B, the airflow 394 is less abundant (less air flows per unit time) when the fans 380 are operated at the same given fan speed as before. Of course, it may be possible for the fans 380 to be operated at a higher speed in the state of FIG. 3B in order to make up the difference in airflow, but this would require the fans consuming more power to achieve the same cooling effect. Accordingly, in the clogged state of FIG. 3B, the cooling efficiency of the fans 380 (the airflow provided per unit of energy consumed) decreases due to the gradual clogging of the air filter 392. Furthermore, the lower airflow rate achieved in the state of FIG. 3B, assuming the same fan speed is used, will result in the server components of the system 300, such as the monitored component 360, undergoing cooling at a lower cooling rate as compared to using a new, clean air filter 392.

Because the cooling performance is inversely proportional to thermal resistance, a reduction in the cooling effect due to a clogged filter 392 results in an increase in thermal resistance. In other words, the thermal resistance of the component 360 depends on the cooling performance of the component 360 which in turn depends on the rate of airflow 394 which in turn depends on the condition of the filter 392. Consequently, it can be inferred that when the thermal resistance of the component 360 rises, at a given fan speed, this indicates an increase in obstruction of the filter 392. Thus, the controller 320 may use the computation of the thermal resistance of the component 360 to evaluate the condition of the filter 392. To this end, controller 320 may perform operations similar to those described above in relation to controller 120.

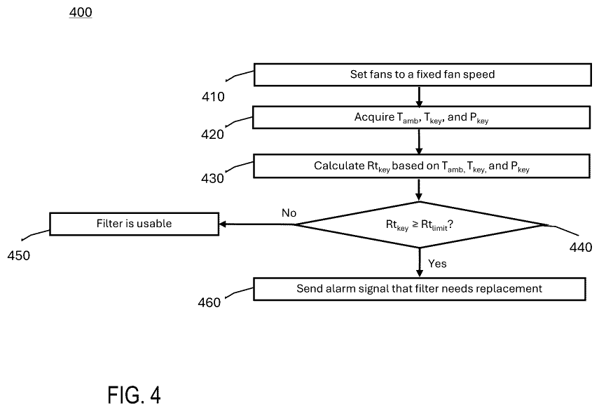

FIG. 4 illustrates an example method 400 for filter condition monitoring and filter replacement determination. Method 400 may be performed by any suitable combination of controllers, such as controller 120. Although FIG. 4 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 400 begins at step 410, where the controller 120 initiates a filter test and sets the fans to a predetermined fixed fan speed. In some examples, step 410 may include the processor 130 retrieving and executing fan speed control instructions 152. The instructions 152 stored in the memory 140 may include setting up the fan speed to a predetermined value. The controller 120 may directly set the fan speed, such as by sending a PWM fan speed control signal to the fans, or may indirectly set the fan speed, such as by sending an instruction or request to another controller which controls the fan speed. In one example, the constant fan speed is set to be greater than 50% of the capacity of the fans 180. In another example, the constant fan speed set is set approximately at 100% of the capacity of the fans 180.

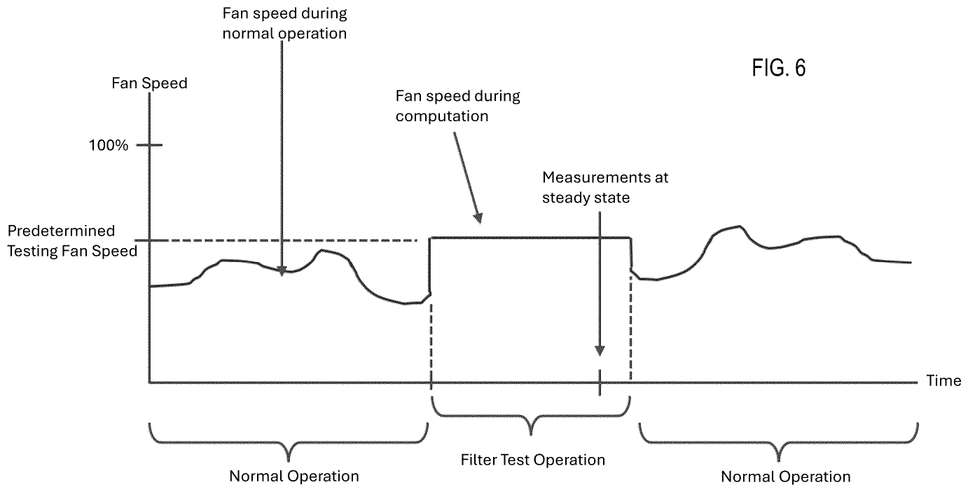

As shown in FIG. 6, during normal operations, the fan speed may vary in a feedback loop based on sensed temperatures. Namely, as the server load changes, a variable amount of heat is generated by the components of the system. In response, the fan speed varies to provide adequate cooling that corresponds to the generated heat. More specifically, temperatures may be sensed (such as Tkey) and the fan speeds may be controlled based on these temperatures, e.g., according to a so-called fan curve. However, if Rtkey were determined under such changing fan speeds, this would impair the ability to infer the condition of the filter based on Rtkey. As previously mentioned, thermal resistance will change based on fan speed. Thus, if the fan speed is not controlled to a known fixed value, it cannot necessarily be inferred that a high Rtkey implies that the filter needs replacement because it could be that Rtkey is high for some other reason, such as the variable fan speed. In order to allow for the inference that a high Rtkey implies the filter needs replacement, other variables which could influence Rtkey need to be controlled form. Thus, during a filter condition test operation, as part of step 410, the normal fan operation mode may be temporarily suspended and instead a filter test fan operation mode is entered. In the filter test fan operation mode, the fan speed is set to a fixed (unchanging) and predetermined value, as shown in FIG. 6. This value may be a same value for the fan speed which was used when determining Rtlimit, and thus the comparison of Rtkey to Rtlimit is congruous.

As explained in reference to FIG. 2, when the fans 180 operate at a very low speed, the ability of the fans 180 to overcome moderate particle blockage in the air filter 192 may be inadequate, thereby creating a potential of false alarms, where a still usable filter 192 is deemed dispensable. On the other hand, the high speed of the fans 180 significantly bolsters the airflow within the system 100 even with a moderately clogged filter 192. Therefore, having the controller 120 instruct the fans 180 to operate at a high (or maximum) speed renders the scrutiny of the cooling efficiency in the subsequent steps more reliable, and accordingly, warnings regarding the condition of the air filter 192 are more credible.

The assessment of the cooling efficiency of the system 100 begins in step 420, when data is gathered to compute a physical property of a component of the system 100 indicative of the system's airflow. More specifically, step 420 comprises the controller 420 acquiring (e.g., reading, sensing, measuring, gathering, etc.) temperature and power test data, which may include Tamb, Tkey, and Pkey. In one example, the system component that is selected as representative of the system 100 as a whole is the monitored component 160 and the physical property that is reflective of its cooling efficiency is thermal resistance (Rt) of the monitored component 160. Accordingly, data gathered in step 420 are variables measured to produce input required for the computation of Rt of the monitored component 160.

In one instance, Equation 1 is used to determine Rt of the monitored component 160 (Rtkey). Hence, in step 420, the ambient sensor 190 measures ambient temperature Tamb, which may be a reference temperature, or a baseline temperature used for computing Rtkey. The ambient sensor 190 may be positioned near the monitored component 160, or at the air inlet 191, or at any other location within the system 100 deemed appropriate for acquiring baseline temperature information.

Further in step 420, the component sensor 170 measures the temperature of the monitored component 160 Tkey. In instances where multiple components of the system 100 are used as representative of the cooling efficiency of the system 100, each of the multiple components may have a separate temperature sensor.

In one example, the controller 120 combines the data from multiple components to compute an aggregate thermal resistance and then uses the computed aggregate value as Rtkey. The aggregate could include any statistical aggregation of the individual thermal resistances of the components, such as an average, a weighted average, a median, a mode, etc.

In another example, the controller 120 performs the Rtkey computation for each of multiple components, each time using one component for comparison with Rtlimit. If the controller 120 determines that replacement is recommended based on any one of the components (or a predetermined number or proportion of components), then the alarm signal is generated.

In yet another example, the controller 120 selects one component as the determining factor during each comparison with Rtlimit, but the selected component can change periodically or occasionally. For example, the controller 120 may pick the component which has the highest, lowest, or median thermal resistance as being representative for a particular determination.

In addition, as further shown in Equation 1, Rtkey may be a function of the power consumption of the monitored component 160 (Pkey). Namely, the greater Pkey is, the greater the demand is for the monitored component 160 to surrender the generated heat to the surrounding air via convection. Such increased (or decreased) demand for cooling needs to be accounted for to determine the airflow within the system 100. Consequently, in step 420, Pkey is provided to the processor 130 as input.

In some examples, the measurement of Tamb and They may take place a predetermined period of time after the filter test operation is initiated. This waiting period may allow for a steady state for the temperatures to be reached in response to the change in fan speed, as temperatures do not instantly respond to fan speed changes.

In step 430, the controller 120 calculates Rtkey based on the gathered data representing Tamb, Tkey, and Pkey. In some examples, this may comprise the processor 130 retrieving and executing thermal resistance calculation instructions 154 stored in the memory 140. The controller 120 computes the information received in step 420, i.e., Tamb, Tkey, and Pkey to calculate Rtkey consistent with Equation 1.

In one example, multiple components of the system 100 are used as representative of the cooling efficiency of the system 100. Hence, in step 430, the controller 120 computes the information received in step 420 corresponding to Tamb, Tkey, and Pkey of each of the multiple components to calculate the overall system Rtkey.

In step 440, the controller 120 compares Rtkey to a threshold Rtlimit and determines whether Rtkey is greater than or equal to the threshold Rtlimit. In some examples, this may comprise the processor 130 retrieving and executing thermal resistance comparing instructions 156 stored in the filter life instructions 150 of the memory 140. In particular, the processor 130 may retrieve Rtlimit stored in the memory 140 to be applied as a thermal resistance threshold.

Rtlimit may correspond to a value of the thermal resistance of the monitored component 160 at which point the cooling efficiency of the monitored component 160 is considered inadequate, thus requiring action. This reduction in the cooling efficiency can be attributed to an excessively clogged air filter 192. In other words, when Rtkey reaches or exceeds the Rtlimit threshold, it is identified as the point at which the air filter 192 is no longer effective and should be replaced.

Being that Rtkey is compared with Rtlimit, Rtlimit may be established at the predetermined testing fan speed, shown in FIG. 6, in order for the Rtkey fan speed conditions to match the Rtlimit fan speed conditions.

If the determination of step 440 is affirmative (i.e., Rtkey is greater than or equal to Rtlimit), the process continues to step 460 in which controller 120 sends an alarm signal that the filter needs replacement. This may include the controller 120 generating alarm signal 194, which may, in some examples, result in activating the alarm 193. The alarm 193 may provide a warning informing the server operator that it is time to remove and replace the used-up air filter 192. The sending of the alarm signal may be part of the thermal resistance comparing instructions 156 executed by processor 130, in some examples.

On the other hand, if the determination of step 440 is negative, the process continues to step 450. In step 450, the controller 450 determines that the filter is still usable (does not need replacement). The controller 450 may, in some examples, send a notification indicating this, such as by sending a digital message, displaying an icon or text in a graphical user interface (GUI), turning on (or off) a light on the server, etc. These operations may be part of the thermal resistance comparing instructions 156 executed by the processor 130. After steps 450 or 460 are reached, the process may end. Although not illustrated, at the end of the process, fan speed control may be returned to a normal fan operation mode.

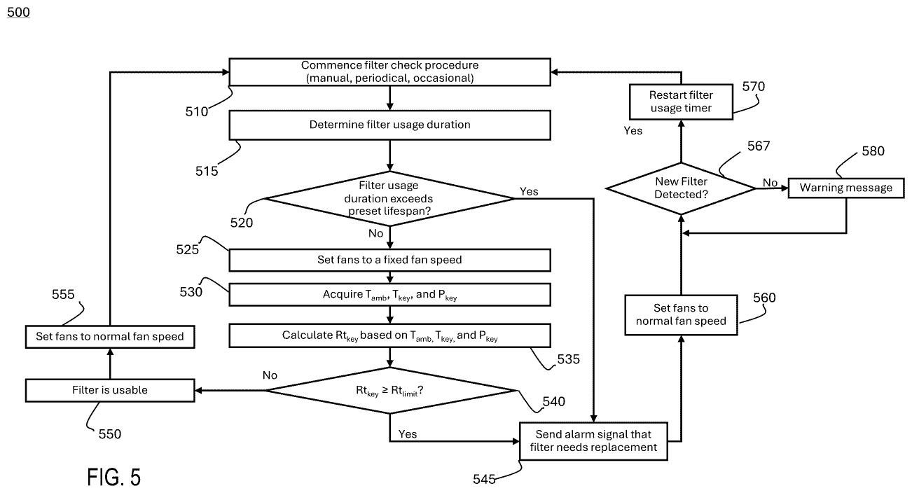

FIG. 5 illustrates an example method 500 for monitoring filter condition and determining when to replace a filter. Method 500 may be performed by any suitable controller, such as controller 120. Although FIG. 5 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Note that some of the steps of method 500 correspond to the steps of method 400, specifically steps 525 through 550. These steps may be characterized as providing a filter condition testing procedure based on measured thermal resistance. Other steps of the method 500 may integrate this measurement based filter condition testing into a larger filter replacement regime, which may further condition filter replacement on other factors besides the measured thermal resistance. In particular, method 500 may combine aspects of periodically scheduled filter replacement with the measurement-based filter replacement. This may allow for regularly scheduled replacement intervals to still be used, which may help to even further lower the risk that an overly clogged filter remains in use, while also allowing for the detection of filters which become clogged prior to their regularly scheduled replacement timing.

Method 500 begins at step 510 the system 100 may initiate a filter check procedure. In one example, controller 120 is configured to (e.g., via filter life instructions 150) initiate a filter check periodically, e.g. weekly, every two weeks, every month or any other period of time deemed appropriate to the server environment. In another example, the filter check may be user initiated, e.g., manually by pressing a physical button. Further, the user interface may allow for a virtual button to be pressed or an entry of a command in a command line interface commencing the filter check procedure. Moreover, the filter check may be started occasionally by a particular event mandating a filter evaluation, such as anomalous controller 120 behavior, the fans 180 operating at 100% capacity in the normal mode for a duration longer than a time threshold, etc.

In step 515, the controller 120 determines a filter usage duration value. The filter usage duration value indicates how long the filter has been in use. In one example, the system 100 includes a filter timer (not shown) that tracks the filter usage duration value. This timer may be restarted when a new filter is installed and may provide the current filter usage duration value to the controller 120, for example by storing the amount of time in the memory 140. In some examples, the timer may track the amount of time that has elapsed since the filter was first installed, regardless of actual serve usage during that period. In other examples, the timer may track an amount of time since the filter was installed during which the server was active.

In step 520, the controller 120 determines whether the filter usage duration value determined in step 515 exceeds a present filter lifespan value. This present filter lifespan value may correspond to a scheduled filter replacement frequency. In some examples, step 520 comprises the processor 130 reading from the memory 140 the preset frequency of the required filter replacement and comparing it to the filter usage duration value obtained in step 510.

If the determination in step 520 is affirmative (i.e., the filter usage duration value exceeds the preset lifespan), then the process continues to step 545. In step 545, the controller 120 deems the filter to be in need of replacement and sends an alarm indicating this. The process then continues to step 560, wherein the fans are returned to their normal fan speed operational mode, if applicable. The process then continues to step 567. In one example, the activated alarm signal may correspond to an instance where the cause of the replacement of the filter is the exceeded recommended duration of the filter usage, apart from other causes of replacement, such as, e.g., clogging of the filter. And the alarm signals corresponding to other triggers for replacement may be distinct from the signal indicating the exceeded duration of the filter usage.

In step 567, the system 100 inquires whether a new air filter 192 is detected, and if the air filter 192 is missing in the filter socket of the server. More specifically, if the system 100 detects that the old filter 192 is still installed, the system 100 may continue to issue the alarm signal 194 and may then perform step 567 again at a later time, with this loop repeating until the system 100 detects that the old filter 192 has been removed. If the old filter 192 has been detected as being removed, then in step 567 the system 100 will determine whether a new filter 192 has been installed, and if not the process proceeds to step 580, in which the system 100 issues a warning message that no air filter is present at the inlet 191 of the server. The system 100 will continue to check whether a new filter is detected in step 567, and continue to issue the warning message in step 580, until a new filter is mounted at the inlet 191 and the affirmative determination is made in step 567. As the new, clean filter is installed, the filter timer is reset in step 570 and the operation of the new filter begins.

The determinations of step 567 may include the system 100 detecting whether an air filter 192 is present and, if so, whether that filter 192 is old or new. The filter presence detection can be conducted using a sensor (not illustrated) arranged to sense a parameter indicative of filter presence or absence, such as a pressure sensor arranged to be contacted by an installed filter, an optical sensor configured to visually observe an installed filter 192, an RFID sensor configured to sense an RFID chip in an installed filter 192, or any other suitable sensor. In some cases, the determination of whether an installed filter is old or new may be based on information gathered by a sensor, such as filter identification information gathered by an RFID sensor from an RFID chip in the filter 192, filter identification information gathered by an optical sensor from a QR code on the filter 192, or the like. In some cases, the determination of whether an installed filter is old or new may be based on information gathered from an electronic record. For example, a user may, upon replacement of a filter, press a button or otherwise cause the system to record information in the record indicating that replacement has occurred and the time of the replacement, and the system may deduce from this stored information that the detected sensor is new.

However, if the system 100 renders a negative determination in step 520, meaning that the filter usage duration does not exceed the preset lifespan (i.e., the air filter 192 has been operational for a period of time shorter than the preset frequency of the required filter replacement), then a filter replacement test operation corresponding to the method 400 described above is performed. Specifically, if the determination in step 520 is negative, the process continues to steps 525 through 550, which correspond to the steps of the method 400.

In step 525, the controller 120 initiates the filter test and causes the fan speed to be set to the predetermined testing fan speed for the duration of the test, as shown in FIG. 6. The controller 120 may directly control the fan speed (e.g., sending PWM fan signals to the fans), or the controller 120 may set the fan speed by sending an instruction or request to another controller which controls the fan speed. In one example, the constant fan speed is set to be greater than 50% of the capacity of the fans 180. In another example, the constant fan speed set is set approximately at 100% of the capacity of the fans 180.

In step 530, the controller 120 gathers data reflecting Tamb, Tkey, and Pkey, as explained above in relation to step 420 of method 400.

In step 535, the controller 120 calculates Rtkey based on Tamb, Tkey, and Pkey, as explained above in relation to step 430 of method 400.

In step 540, the controller 120 determines whether Rtkey is greater than or equal to Rtlimit, as explained above in relation to step 440 of method 400.

If the determination of step 540 is affirmative, the process continues to step 545. As previously mentioned, in step 545, the controller 120 activates the alarm 193. The alarm 193 may provide a warning informing the server operator that it is time to remove and replace the used-up air filter 192. In one example, the activated alarm signal may correspond to an instance where the cause of the replacement is clogging of the filter, apart from other causes of replacement, such as, e.g., exceeded duration of the filter usage. And the alarm signals corresponding to other triggers for replacement may be distinct from the alarm signaling the clogging of the filter by dust particles.

In some examples, different types of alarm signals may be generated depending on how step 545 has been reached, e.g., depending on whether the cause of the replacement of the filter is that its usage duration has exceeded its preset lifespan (i.e., determination in step 520 is answered in the affirmative), or that the thermal resistance of the monitoring component exceeds the threshold (i.e., determination in step 540 is answered in the affirmative). In some of these examples, the different alarm signals may activate different alarm devices (e.g., light different lights), activate the same alarm device in different ways (e.g., cause a light to illuminate in one color for one alarm signal and in a different color for another alarm signal), and/or may comprise different notifications (e.g., including differing text indicative of the different reasons for the triggering of the alarm).

Upon providing the alarm, the process continues to step 560 the controller 120 sets the fans 180 to normal fan speed, as shown in FIG. 6, and then to steps 567, 580, and 570 as already described above.

On the other hand, if the determination of step 540 is negative, the process continues to step 550 and the controller 120 renders a decision that the filter 192 does not need to be replaced yet and may remain in operation. Although not illustrated, the controller 120 may send a notification that the filter does not need to be replaced. Further, in step 555 the controller 120 sets the fans 180 to normal fan speed.

It is to be understood that both the general description and the detailed description provide examples that are explanatory in nature and are intended to provide an understanding of the present disclosure without limiting the scope of the present disclosure. Various mechanical, compositional, structural, electronic, and operational changes may be made without departing from the scope of this description and the claims. In some instances, well-known circuits, structures, and techniques have not been shown or described in detail in order not to obscure the examples. Like numbers in two or more figures represent the same or similar elements.

In addition, the singular forms “a,” “an,” and “the” are intended to include the plural forms as well, unless the context indicates otherwise. Moreover, the terms “comprises,” “comprising,” “includes,” and the like specify the presence of stated features, steps, operations, elements, and/or components but do not preclude the presence or addition of one or more other features, steps, operations, elements, components, and/or groups. Components described as connected may be electronically or mechanically directly connected, or they may be indirectly connected via one or more intermediate components, unless specifically noted otherwise. Mathematical and geometric terms are not necessarily intended to be used in accordance with their strict definitions unless the context of the description indicates otherwise, because a person having ordinary skill in the art would understand that, for example, a substantially similar element that functions in a substantially similar way could easily fall within the scope of a descriptive term even though the term also has a strict definition.

And/or: Occasionally the phrase “and/or” is used herein in conjunction with a list of items. This phrase means that any combination of items in the list—from a single item to all of the items and any permutation in between—may be included. Thus, for example, “A, B, and/or C” means “one of {A}, {B}, {C}, {A, B}, {A, C}, {C, B}, and {A, C, B}.”

Elements and their associated aspects that are described in detail with reference to one example may, whenever practical, be included in other examples in which they are not specifically shown or described. For example, if an element is described in detail with reference to one example and is not described with reference to a second example, the element may nevertheless be claimed as included in the second example.

Unless otherwise noted herein or implied by the context, when terms of approximation such as “substantially,” “approximately,” “about,” “around,” “roughly,” and the like, are used, this should be understood as meaning that mathematical exactitude is not required and that instead a range of variation is being referred to that includes but is not strictly limited to the stated value, property, or relationship. In particular, in addition to any ranges explicitly stated herein (if any), the range of variation implied by the usage of such a term of approximation includes at least any inconsequential variations and also those variations that are typical in the relevant art for the type of item in question due to manufacturing or other tolerances. In any case, the range of variation may include at least values that are within ±1% of the stated value, property, or relationship unless indicated otherwise.

Further modifications and alternative examples will be apparent to those of ordinary skill in the art in view of the disclosure herein. For example, the devices and methods may include additional components or steps that were omitted from the diagrams and description for clarity of operation. Accordingly, this description is to be construed as illustrative only and is for the purpose of teaching those skilled in the art the general manner of carrying out the present teachings. It is to be understood that the various examples shown and described herein are to be taken as examples. Elements and materials, and arrangements of those elements and materials, may be substituted for those illustrated and described herein, parts and processes may be reversed, and certain features of the present teachings may be utilized independently, all as would be apparent to one skilled in the art after having the benefit of the description herein. Changes may be made in the elements described herein without departing from the scope of the present teachings and following claims.

It is to be understood that the particular examples set forth herein are non-limiting, and modifications to structure, dimensions, materials, and methodologies may be made without departing from the scope of the present teachings.

Other examples in accordance with the present disclosure will be apparent to those skilled in the art from consideration of the specification and practice of the invention disclosed herein. It is intended that the specification and examples be considered as examples only, with the following claims being entitled to their fullest breadth, including equivalents, under the applicable law.

What is claimed is:

1. A method, comprising:
initiate a filter test by setting a speed of one or more cooling fans of an information processing system to a predetermined speed for a duration of the filter test,
acquire temperature and power test data of one or more components associated with the information processing system during the filter test,
calculate a thermal resistance of the one or more components for the filter test based on the temperature and power test data, and
in response to determining that the thermal resistance of the one or more components is greater than or equal to a thermal resistance threshold, issue a notification to replace an air filter of the information processing system.

2. The method of claim 1, wherein the thermal resistance of the one or more components of the information processing system is representative of an overall cooling efficiency of the information processing system.

3. The method of claim 1, wherein the temperature and power test data comprises data indicating: an ambient air temperature inside the information processing system, a temperature of the one or more components, and power consumption of the one or more components.

4. The method of claim 3, wherein the ambient air temperature is indicative of the temperature of air reaching the one or more components prior to being heated by the one or more components.

5. The method of claim 4, wherein the one or more components comprises a first component and acquiring the temperature and power test data comprises sensing the ambient air temperature by a sensor of the information processing system disposed in an airflow path to the first component, upstream of the first component.

6. The method of claim 1, wherein the predetermined speed is in a range between 50% and 100% of a maximum fan speed of the one or more cooling fans.

7. The method of claim 1, further comprising, prior to initiating the filter test, performing an air filter baseline determination process comprising:
initiating a baseline test and setting the speed of one or more cooling fans to the predetermined speed for a duration of the baseline test;
acquiring temperature and power baseline data during the baseline test;
calculating the thermal resistance of the one or more components for the baseline test based on the temperature and power baseline data; and
setting the thermal resistance threshold to equal the calculated thermal resistance for the baseline test plus a predetermined offset.

8. The method of claim 7, wherein the air filter baseline determination process is performed in response to one or more of:
detecting a first system startup;
detecting a change in configuration of the information processing system; and
detecting a change in an external environment of the information processing system.

9. The method of claim 8, wherein the change in configuration of the information processing system comprises one or more of: an installation of a new air filter, an installation of a new electronic component, and a removal of an electronic component.

10. The method of claim 1, wherein acquiring the temperature and power test data of the one or more components comprises:
measuring temperature of the one or more components using a temperature sensor, and
measuring power consumption of the one or more components using at least one of: a power delivery circuit and a power sensor.

11. The method of claim 10, wherein the usage of the air filter comprises a first stage of usage of the air filter, when the air filter is clean, and a second stage of usage of the air filter, when the air filter is dispensable,
wherein a difference between thermal resistances of the one or more components at the second stage and at the first stage increases as the speed of one or more cooling fans increases.

12. An information processing system comprising:
a chassis;
an air filter holder configured to removably receive an air filter;
one or more cooling fans housed in the chassis and configured to flow air through the chassis; and
one or more information processing components housed in the chassis and including one or more hardware processors comprising air filter replacement testing logic configured to:
initiate a filter test and set a speed of one or more cooling fans of an information processing system to a predetermined speed for a duration of the filter test,
acquire temperature and power test data indicative of thermal resistance of one or more components of the information processing system during the filter test,
calculate the thermal resistance of the one or more components for the filter test based on the temperature and power test data, and
in response to determining that the thermal resistance of the one or more components is greater than or equal to a thermal resistance threshold, issue a notification to replace an air filter of the information processing system.

13. The information processing system of claim 12, wherein the thermal resistance of the one or more components of the information processing system is representative of an overall cooling efficiency of the information processing system.

14. The information processing system of claim 12, wherein the temperature and power test data comprise data indicating: an ambient air temperature inside the system, a temperature of the one or more components, and power consumption of the one or more components.

15. The information processing system of claim 14, wherein the ambient air temperature is indicative of the temperature of air reaching the one or more components prior to being heated by the one or more components.

16. The information processing system of claim 15, further comprising a sensor disposed in an airflow path to and upstream of a first component of the one or more components, and wherein the air filter replacement testing logic is further configured to cause the sensor to sense the ambient air temperature.

17. A non-transitory computer readable medium storing instructions executable by a processor to cause the processor to:
initiate a filter test and set a speed of one or more cooling fans of an information processing system to a predetermined speed for a duration of the filter test,
acquire temperature and power test data indicative of thermal resistance of one or more components of the information processing system during the filter test,
calculate the thermal resistance of the one or more components for the filter test based on the temperature and power test data, and
in response to determining that the thermal resistance of the one or more components is greater than or equal to a thermal resistance threshold, issue a notification to replace an air filter of the information processing system.

18. The non-transitory computer readable medium of claim 17, the instructions are further configured to cause the processor to prior to initiating a filter test, perform an air filter baseline determination process comprising:
initiating a baseline test and setting the speed of one or more cooling fans to a predetermined speed for a duration of the baseline test;
acquiring temperature and power baseline data during the baseline test;
calculating the thermal resistance of the one or more components for the baseline test based on the temperature and power baseline data; and
setting the thermal resistance threshold to equal the calculated thermal resistance for the baseline test plus a predetermined offset.

19. The non-transitory computer readable medium of claim 18, wherein the instructions are further configured to cause the processor to perform the air filter baseline determination process in response to one or more of:
detecting a first system startup;
detecting a change in configuration of the information processing system; and
detecting a change in an external environment of the information processing system.

20. The non-transitory computer readable medium of claim 19, wherein the change in configuration of the information processing system comprises one or more of: an installation of a new air filter, an installation of a new electronic component, and a removal of an electronic component.
